(19) United States
(12) Patent Application Publication
(10) Pub. No.: US 2024/0375492 A1
(43) Pub. Date: Nov. 14, 2024

(54) VEHICLE WINDOW-REGULATOR ASSEMBLY

(71) Applicant: Ford Global Technologies, LLC, Dearborn, MI (US)

(72) Inventors: Zhibing Deng, Northville, MI (US); Joseph E. Abramczyk, Farmington Hills, MI (US); Deepak Patel, Canton, MI (US)

(73) Assignee: Ford Global Technologies, LLC, Dearborn, MI (US)

(21) Appl. No.: 18/314,188

(22) Filed: May 9, 2023

(51) Int. Cl. B60J 5/04; B60J 1/17; B60R 7/04; B60R 13/02; E05F 15/689

(52) U.S. Cl. CPC B60J 5/0461; B60J 1/17; B60J 5/0413; B60J 5/0415; B60J 5/0451; B60J 5/0484; B60R 7/046; B60R 13/0243; E05F 15/689; E05Y 2201/684; E05Y 2600/46

(57) ABSTRACT

A vehicle comprising: a seat including a seat bottom and a seatback. The seat bottom defines a pelvic-seating area. A includes an exterior-door panel and a door-trim panel supported by and fixed to the exterior-door panel vehicle-inboard of the exterior-door panel. The door includes a window-regulator assembly between the exterior-door panel and the door-trim panel. The window-regulator assembly includes a panel supported by and fixed to the exterior-door panel and a window-regulator motor supported by the panel. The door-trim panel has a vehicle-inboard face and recessed wall recessed vehicle-outboard of the vehicle-inboard face defining a map pocket. The map pocket is adjacent to the seat. The window-regulator assembly includes a polymeric block attached to and supported by the panel. The map pocket is between the polymeric block and the pelvic-seating area when the door is in the closed position.

### BACKGROUND

Vehicles may be subject to impact tests to test the movement of vehicle occupants. Such tests may be standardized by various governmental or industry organizations. Some tests, for example, measure the door intrusion and/or the movement of vehicle occupants during vehicle certain impacts that move the vehicle occupants in cross-vehicle directions. These tests include side impact tests and oblique impact tests. For example, FMVSS 214 mandates static door intrusion requirement and dynamic impact limits on occupants of a vehicle. Some public domain organizations such as IIHS also test for kinematic control of occupants during dynamic side impacts.

### BRIEF DESCRIPTION OF THE DRAWINGS

FIG. 1 is a cut-away view of a front portion of a vehicle.

FIG. 2 is an exploded view of a door of the vehicle.

FIG. 3 is a partially-exploded view of the door of FIG. 2.

FIG. 4 is a perspective view of a window-regulator assembly including a panel, a motor, and a polymeric block.

FIG. 5 is a cross-sectional view of the door along line 5-5 in FIG. 8.

FIG. 6 is a magnified portion of FIG. 5.

FIG. 7 is the cross-sectional view of FIG. 6 during an impact to the door.

FIG. 8 is a side view of the door from the view of a passenger compartment of the vehicle.

### DETAILED DESCRIPTION

A vehicle includes a seat including a seat bottom and a seatback. The seat bottom defines a pelvic-seating area. The vehicle includes a door adjacent to the seat and positioned vehicle-outboard of the seat. The door is moveable between an open position and a closed position. The door includes an exterior-door panel and a door-trim panel supported by and fixed to the exterior-door panel vehicle-inboard of the exterior-door panel. The door includes a window-regulator assembly between the exterior-door panel and the door-trim panel. The window-regulator assembly includes a panel supported by and fixed to the exterior-door panel and a window-regulator motor supported by the panel. The door-trim panel has a vehicle-inboard face and a recessed wall recessed vehicle-outboard of the vehicle-inboard face defining a map pocket. The map pocket is adjacent to the seat. The window-regulator assembly includes a polymeric block attached to and supported by the panel. The map pocket is between the polymeric block and the pelvic-seating area when the door is in the closed position.

The door-trim panel may include a wall connected to the vehicle-inboard face and extending across the map pocket vehicle-inboard from the recessed wall.

The door may include a window track fixed relative to the panel and a window slidable along the window track. The window-regulator motor is operatively coupled to the window to move the window along the window track. The window-regulator assembly may include a mechanism between the regulator and the window designed to move the window relative to the window track. The mechanism may be between the exterior-door panel and the panel of the window-regulator assembly. A portion of the window track may extend between the exterior-door panel and the panel of the window-regulator assembly. The panel of the window-regulator assembly may provide a reaction surface for the window-regulator motor when the window-regulator motor moves the window relative to the window track.

The panel of the window-regulator assembly may be fixed to the exterior-door panel with fasteners.

The polymeric block may be adhered to the panel.

The panel may include a weakened area at the polymeric block. The weakened area is designed to break from an adjacent area of the panel.

The polymeric block may include hollow cells elongated cross-vehicle.

The polymeric block may abut the recessed wall of the door-trim panel.

The polymeric block may be vehicle-forward of the window-regulator motor. The polymeric block may be vertically aligned with the window-regulator motor.

The exterior-door panel may include a door inner and a door outer. The window-regulator assembly may be fixed directly to the door inner. The door-trim panel may be fixed directly to the door inner.

The exterior-door panel may be metal and the door-trim panel may be polymeric.

With reference to the Figures, wherein like numerals indicate like parts throughout the several views, a vehicle 10 includes a seat 12 including a seat bottom 14 and a seatback 16. The seat bottom 14 defines a pelvic-seating area 18. A door 20 is adjacent to the seat 12 and is positioned vehicle-outboard of the seat 12. The door 20 is moveable between an open position and a closed position. The door 20 includes an exterior-door panel 22 and a door-trim panel 24 supported by and fixed to the exterior-door panel 22 vehicle-inboard of the exterior-door panel 22. The door 20 includes a window-regulator assembly 26 between the exterior-door panel 22 and the door-trim panel 24. The window-regulator assembly 26 includes a panel 28 supported by and fixed to the exterior-door panel 22 and a window-regulator motor 30 supported by the panel 28. The door-trim panel 24 has a vehicle-inboard face 32 and recessed wall 34 recessed vehicle-outboard of the vehicle-inboard face 32 defining a map pocket 36. The map pocket 36 is adjacent to the seat 12. The window-regulator assembly 26 includes a polymeric block 38 attached to and supported by the panel 28. The map pocket 36 is between the polymeric block 38 and the pelvic-seating area 18 when the door 20 is in the closed position.

The positioning of the polymeric block 38 such that the map pocket 36 is between the polymeric block 38 and the pelvic-seating area 18 reduces unoccupied cross-vehicle space between the exterior-door panel 22 and the pelvic-seating area 18. During certain impacts to the exterior-door panel 22 (e.g., due to certain vehicle impacts), vehicle-inboard deformation of the exterior-door panel 22 moves the polymeric block 38 into the map pocket 36 toward the pelvic-seating area 18. This deforms the door-trim panel 24 into the map pocket 36 such that the polymeric block 38 and the door-trim panel 24 occupy the space previously defined by the map pocket 36 prior to deformation. The door-trim panel 24 and the polymeric block 38 can transmit cross-vehicle force from the deforming exterior-door panel 22 to occupant-seating area 42.

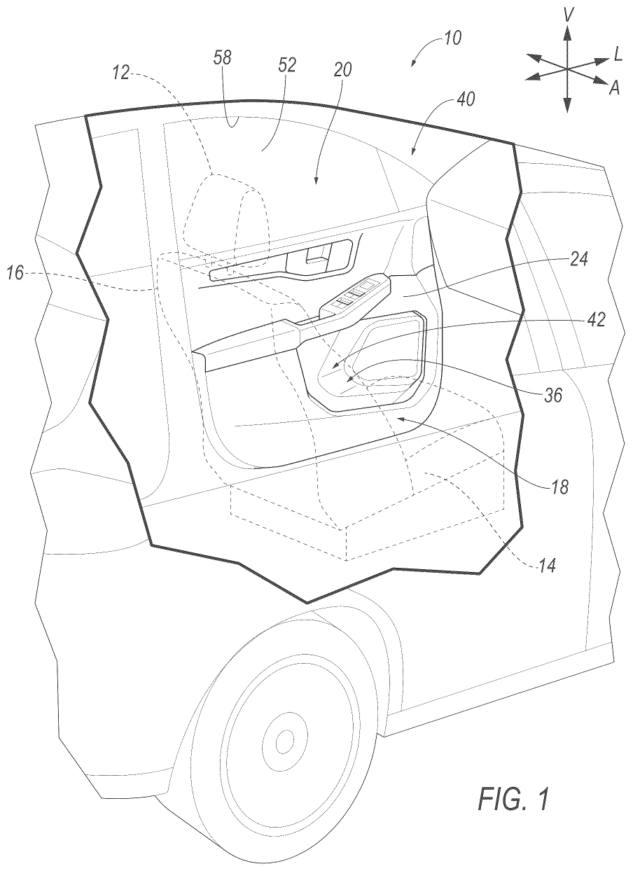

With reference to FIG. 1, the vehicle 10 may be any suitable type of automobile, e.g., a passenger or commercial automobile such as a sedan, a coupe, a truck, a sport utility, a crossover, a van, a minivan, a taxi, a bus, etc. With reference to FIG. 1, the vehicle 10 defines a vehicle-longitudinal axis L extending between a front end (not numbered) and a rear-end (not numbered) of the vehicle 10. The vehicle 10 defines a vehicle-lateral axis A extending cross-vehicle from one side to the other side of the vehicle 10. The vehicle 10 defines a vertical axis V. The vehicle-longitudinal axis L, the vehicle-lateral axis A, and the vertical axis V are perpendicular relative to each other. “Vehicle outboard” and “vehicle inboard” directions are along the vehicle-lateral axis A. “Vehicle outboard” and “vehicle inboard” are relative to the vehicle-longitudinal axis L, i.e., a “vehicle-inboard” is toward the vehicle-longitudinal axis and “vehicle-outboard” is away from the vehicle-longitudinal axis.

The vehicle 10 may include a vehicle body (not numbered). The vehicle body includes body panels 28, e.g., the exterior-door panel 22, fenders, a hood, a vehicle roof, a vehicle floor, etc., partially defining an exterior of the vehicle 10. At least some of the body panels may present a class-A surface, e.g., a finished surface exposed to view by a customer and free of unaesthetic blemishes and defects. For example, the exterior-door panel 22 of the door 20 has a class-A surface.

The vehicle 10 includes a passenger compartment 40 to house occupants of the vehicle 10. The passenger compartment 40 may extend across the vehicle 10, i.e., from one side to the other side of the vehicle 10. The passenger compartment 40 includes a front end and a rear end with the front end being in front of the rear end during forward movement of the vehicle 10.

The vehicle body may include pillars (not numbered). The vehicle body may include any suitable number of pillars. For example, the vehicle body may include a front pillar, a middle pillar, and rear pillar on each side of the vehicle 10. The front pillar may be disposed at the front end of the passenger compartment 40. The middle pillars may be spaced from the front pillars by a front door opening (not numbered). The rear pillars may be spaced from the middle pillars by a rear door opening (not numbered). The pillars may extend from the vehicle roof to the vehicle floor.

With continued reference to FIG. 1, the vehicle 10 may include one or more seats 12. Specifically, the vehicle 10 may include any suitable number of seats 12. In the example shown in FIG. 1, one seat 12 is shown. Specifically, in FIG. 1, a front seat, and more specifically, a front-driver seat, is shown. As shown in FIG. 1, the seat 12 is supported by the vehicle floor. The seats 12 may be arranged in any suitable arrangement in the passenger compartment 40. As in the example shown in the Figures, one or more of the seats 12 may be at the front end of the passenger compartment 40, e.g., a front seat such as a driver seat and/or a passenger seat. In other examples, one or more of the seats 12 may be behind the front end of the passenger compartment 40, i.e., rear seats behind the front seats in the passenger compartment 40. The seats may be movable relative to the vehicle floor to various positions, e.g., movable fore-and-aft and/or cross-vehicle. The seat 12 may be of any suitable type, e.g., a bucket seat, a bench seat, etc.

Each seat 12 includes the seatback 16 and a seat bottom 14. The seatback 16 may be supported by the seat bottom 14 and may be stationary or movable relative to the seat bottom 14. The seatback 16 and the seat bottom 14 may be adjustable in multiple degrees of freedom. Specifically, the seatback 16 and the seat bottom 14 may themselves be adjustable. In other words, adjustable components within the seatback 16 and/or the seat bottom 14, and/or may be adjustable relative to each other.

The seat 12, specifically the seatback 16 and the seat bottom 14, defines an occupant-seating area 42. The occupant-seating area 42 is the area occupied by an occupant when properly seated on the seat bottom 14 and the seatback 16. The occupant-seating area 42 is in a seat-forward direction of the seatback 16 and above the seat bottom 14. In the example shown in the Figures, the occupant-seating area 42 faces the front end of the passenger compartment 40. The occupant-seating area 42 includes the pelvic-seating area 18. Specifically, the seat bottom 14 defines the pelvic-seating area 18. The pelvic-seating area 18 is the area occupied by the pelvis of the occupant when properly seated on the seat bottom 14 and the seatback 16.

The vehicle 10 includes a plurality of doors 20 openable for vehicle 10 occupants to enter and exit a passenger compartment 40. The doors 20 may be openable between a closed position and an open position. The vehicle 10 may include any suitable number of doors 20. One door 20, specifically a front door, and more specifically, a front-driver door, is shown in the Figures. On each side of the vehicle 10, the vehicle 10 includes a front door spaced along a vehicle-longitudinal axis L from a rear door. Each of the doors 20 are adjacent to one of the seats 12, respectively. Specifically, each front seat may be adjacent a front door and each rear seat may be adjacent a rear door. The doors 20 are vehicle-outboard from each of the respective seat 12. Any one or all the doors 20 of the vehicle 10 may include the window-regulator assembly 26 including the polymeric block 38.

As set forth above, the vehicle 10 includes pillars adjacent to the doors 20. The vehicle 10 includes a pillar in front of the front door 20, e.g., the front pillar. The vehicle 10 includes a pillar between the front door and the rear door on each side of the vehicle 10, e.g., the middle pillar.

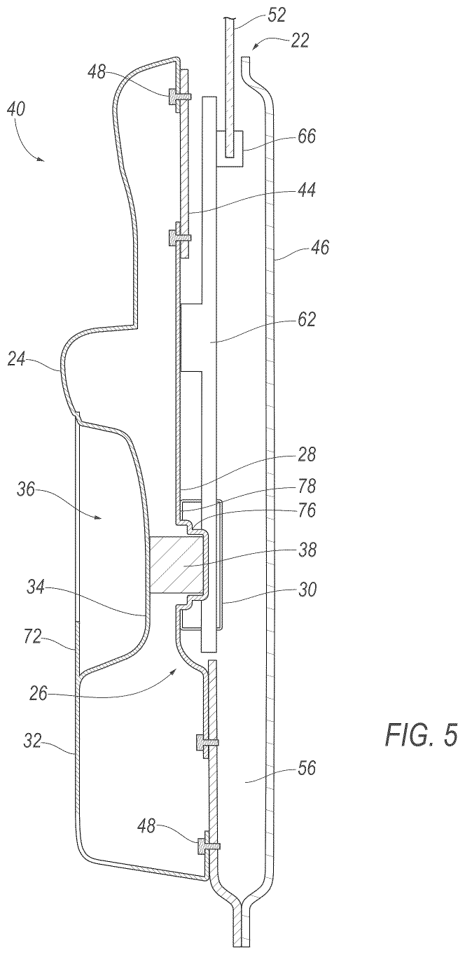

Each door 20 includes the exterior-door panel 22, the door-trim panel 24, and window-regulator assembly 26. The door-trim panel 24 is supported by the exterior-door panel 22. In other words, the weight of the door-trim panel 24 is borne by the exterior-door panel 22 when the door 20 is in the open position. The exterior-door panel 22 may include two panel members, namely a door inner panel 44 and a door outer panel 46. In such an example, the door-trim panel 24 is fixed to the door inner panel 44. The door-trim panel 24 is positioned opposite the door outer panel 46, i.e., with the door inner panel 44 between the door outer panel 46 and the door-trim panel 24. The door-trim panel 24 is vehicle-inboard relative to the door inner panel 44, and the door outer panel 46 is vehicle-outboard of the door inner panel 44. The door-trim panel 24 may be fixed to the exterior-door panel 22, e.g., the door inner panel 44, with a fastener 48 (see FIG. 5), e.g., Christmas-tree fasteners, pushpins, etc. In the example shown in the Figures, the door-trim panel 24 is fixed directly to the door inner panel 44.

The door-trim panel 24 may include a frame (not numbered) and covering that covers the frame. The door-trim panel 24 is polymeric. Specifically, the frame of the door-trim panel 24 may be polymeric. As an example, the frame may be plastic, e.g., polypropylene, acrylonitrile butadiene styrene (ABS), etc. The covering may include upholstery, padding, etc. The upholstery may be cloth, leather, faux leather, or any other suitable material. The upholstery may be stitched in panels around the frame. The padding may be between the covering and the frame and may be foam or any other suitable material.

The door-trim panel 24 includes an armrest elongated along a vehicle-longitudinal direction when the door 20 is in the closed position. The armrest may be used by a vehicle occupant in the seat 12 adjacent to the door-trim panel 24 during operation of the vehicle 10.

The door outer panel 46 may define a portion of the exterior of the vehicle 10. For example, the door outer panel 46 may present a class-A surface, i.e., a surface specifically manufactured to have a high-quality, finished aesthetic appearance free of blemishes. The door inner panel 44 provides structural rigidity for the door outer panel 46. The door inner panel 44 may include fastening features, e.g., holes, brackets, studs, etc., to affix the door-trim panel 24 and the panel 28 of the window-regulator assembly 26. The door outer panel 46 and the door outer panel 46 may be metal (such as steel, aluminum, etc.) or polymeric (such as fiber reinforced plastic composite, etc.). The door inner panel 44 and the door outer panel 46 may be of the same type of material or different types of material.

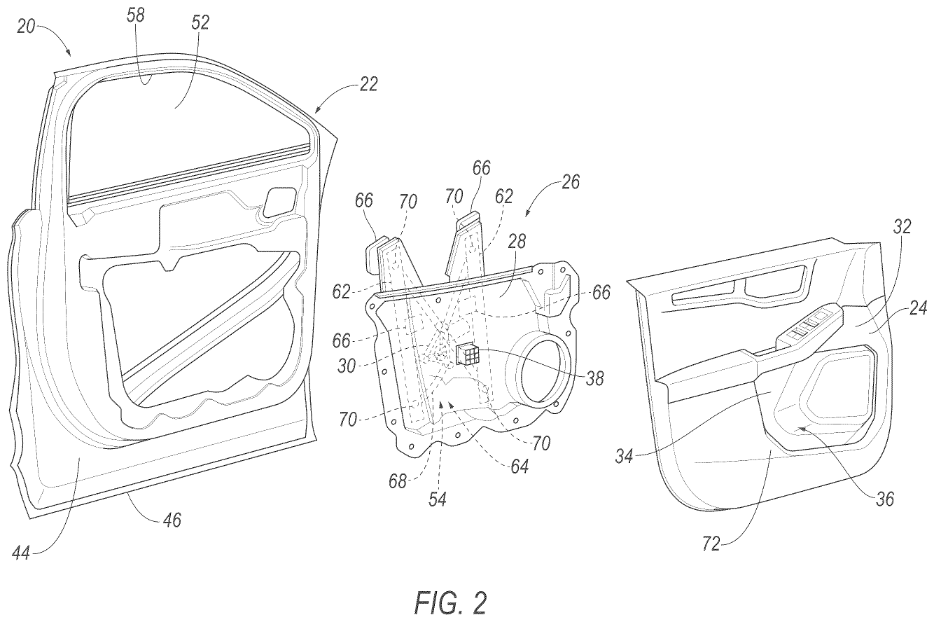

The door inner panel 44 and the door outer panel 46 are fixed to each other, e.g., by hemming, welding, adhesive, etc. The door inner panel 44 and the door outer panel 46 define a cavity 56 therebetween (FIGS. 2 and 5). The cavity 56 may receive door 20 hardware such as electronics. The cavity 56 may receive a door window 52 and window hardware of the window-regulator assembly 26, such as a window-track assembly 54, the window-regulator motor 30, etc. the window-track assembly 54 may retract the door window 52 into the cavity 56 and extend the door window 52 from the cavity 56 to open and close the door window 52.

The door 20 includes a window opening 58 that may be completely closed by the door window 52 when the door window 52 is in a fully raised position. The window opening 58 is defined by the door-trim panel 24 and door outer panel 46 on a bottom edge and either by the door inner panel 44 circumscribing the window opening 58 or by the vehicle body, e.g., pillars and a roof rail. As an example, a slot between the door inner panel 44 and the door outer panel 46 at a bottom of the window opening 58 allows for travel of the door window 52 therebetween between the opened and closed position of the door window 52. The door 20 may include window seals (not shown) that seal against the door window 52. The window seals, for example, are rubber. The door window 52 may be a transparent material, e.g., tempered glass, supported in the window opening 58, as described further below.

The door 20 includes the window-regulator assembly 26. With reference to FIG. 2, the window-regulator assembly 26 includes the window-regulator motor 30, the window-track assembly 54, and the panel 28. The panel 28 is supported by the exterior-door panel 22. For example, in the example shown in the Figures, the panel 28 is supported by the door inner panel 44. In other words, the weight of the panel 28 is borne by the door inner panel 44. The window-track assembly 54 and the window-regulator motor 30 are supported by the panel 28, i.e., the weight of the window-track assembly 54 and the window-regulator motor 30 is borne by the panel 28. Specifically, the weight of the window-track assembly 54 and the window-regulator motor 30 is borne directly by the panel 28 and indirectly by the door inner panel 44, i.e., through the panel 28.

The window-regulator assembly 26 is between the exterior-door panel 22 and the door-trim panel 24. When the door-trim panel 24 is fixed to the exterior-door panel 22, the window-regulator assembly 26 is concealed from view by the door-trim panel 24 and the exterior-door panel 22. The motor and window-track assembly 54 may be between the door-trim panel 24 and door outer panel 46, as shown in the example in the Figures. For example, the motor and window-track assembly 54 may be in the cavity 56.

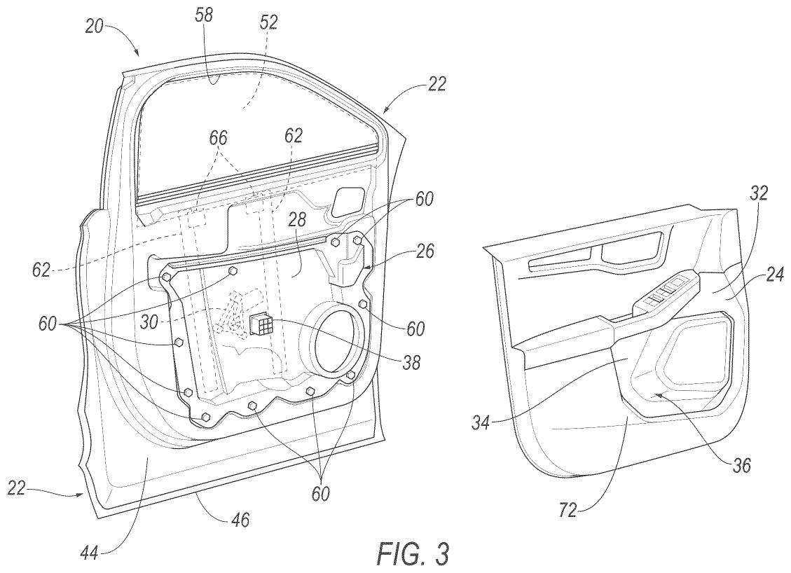

The window-regulator assembly 26 is fixed directly to the exterior-door panel 22. For example, panel 28 is fixed directly to exterior-door panel 22, and more specifically, the door inner panel 44. The window-regulator assembly 26, specifically the panel 28, is fixed to the door inner panel 44 so that the panel 28 is immovable relative to the door inner panel 44 during operation of the window-regulator motor 30. The panel 28 may be fixed by mechanical attachment that requires removal by a service technician with the use of a tool. For example, the window-regulator assembly 26, specifically the panel 28, may be fixed to the door inner panel 44 with a plurality of fasteners 60 (see FIGS. 3 and 5). The fasteners 60 may be, for example, threaded fasteners. In the example shown in the Figures, the panel 28 is fixed directly to the door inner panel 44 with bolts. The bolts may be threadedly engaged with the door inner panel 44, e.g., with threaded holes on the door inner panel 44 and/or weld nuts on the door inner panel 44.

The window-regulator motor 30 is fixed to and supported by the panel 28, i.e., the weight of the window-regulator motor 30 is borne by the panel 28. Since the panel 28 is fixed to the door inner panel 44, the panel 28 provides a reaction surface for the window-regulator motor 30 when the window-regulator motor 30 moves the window relative to the window track 62. In other words, as the window-regulator motor 30 operates to move the window up and down in the window opening 58, the window-regulator motor 30 is grounded to the panel 28, which is grounded to the door inner panel 44, such that the door window 52 moves relative to a window track 62, the window-regulator motor 30, and the panel 28 during operation of the window-regulator motor 30.

The panel 28 is rigid during operation of the window-regulator motor 30 to move the door window 52 relative to the exterior-door panel 22. In other words, the panel 28 does not move and delivers forces from the motor to the door inner panel 44. The panel 28 may be plastic, e.g., polypropylene, acrylonitrile butadiene styrene (ABS), etc.

The window-regulator motor 30 is operatively coupled to the door window 52 to move the door window 52 along the window track 62. For example, the window-regulator assembly 26 includes a mechanism 64 between the window-regulator motor 30 and the window designed to move the window relative to the window track 62. The mechanism 64 may be between the exterior-door panel 22 and the panel 28 of the window-regulator assembly 26. In the example shown in the Figures, with reference to FIG. 2, the window-track assembly 54 includes at least one window track 62, a window clamp 66 on each window track 62, and a cable 68 extending from the window-regulator motor 30 to the window clamp 66. In other examples, the mechanism 64 may include any combination of arms, cables, etc., between the window-regulator motor 30 and the door window 52 to move the door window 52 relative to the exterior-door panel 22.

In the example shown in the Figures, the window-track assembly 54 includes two window tracks 62 and two window clamps 66. The window clamps 66 are fixed to the door window 52 and moveable moveably engaged with the window track 62 for movement powered by the window-regulator motor 30, as described below.

The window clamps 66 are fixed to the door window 52. The door window 52 is at least partially supported by the window clamps 66, i.e., at least some of the weight of the door window 52 is supported by the window clamps 66. The window clamps 66 may be engaged with the door window 52 to move as a unit with the door window 52. As an example, the door 20 clamp may include two plates that clamp the door window 52 therebetween under the force of a threaded fastener.

The window tracks 62 are fixed relative to the panel 28. In the example shown in the Figures, the window tracks 62 are fixed to and supported by the panel 28. The window track 62 may be, for example, fastened to the panel 28. For example, threaded fasteners may fasten the window track 62 to the panel 28. Each window track 62 is elongated. When in position in the door 20 the window tracks 62 are elongated generally upright to move the door window 52 up and down relative to the window opening 58. The window is slidable relative to the window track 62. For example, in the example shown in the Figures in which the window-track assembly 54 includes the window clamps 66, the window clamps 66 are slidable along the window tracks 62. In such an example, the window clamps 66 may be slidably engaged with the window tracks 62 in any suitable fashion. In the example shown in the Figures, a portion of each window track 62 extends between the exterior-door panel 22 and the panel 28 of the window-regulator assembly 26.

With reference to the example shown in FIG. 2, the window-regulator assembly 26 includes a cable 68 engaged with the window-regulator motor 30 and fixed to the window clamps 66. In such an example, the cable 68 is engaged with the window tracks 62 at pulleys 70. When the window-regulator motor 30 is activated, the window-regulator motor 30 moves the cable 68, which simultaneously moves the window clamps 66 relative to their respective window tracks 62. Reversing the rotation of the window-regulator motor 30 reverses the movement of the door window 52 relative to the window opening 58.

The window-regulator motor 30 may be of any suitable type. For example, the window-regulator motor 30 may be a DC motor. The window-regulator motor 30 may have a housing fixed to and supported by the panel 28. As an example, the housing of the window-regulator motor 30 may be fixed to the panel 28 with threaded fasteners.

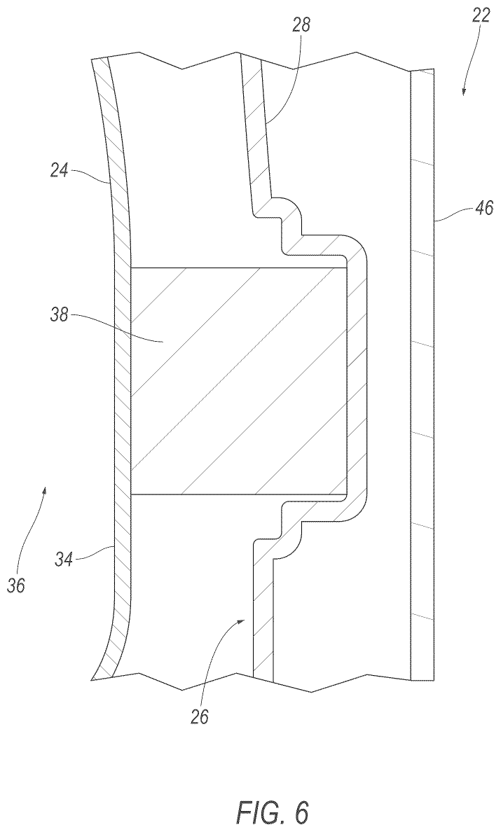

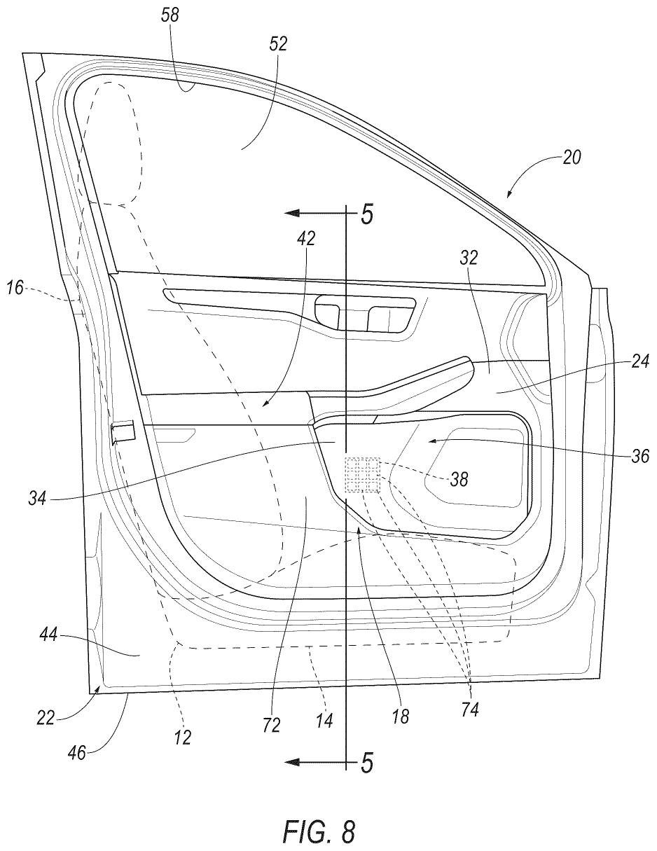

With reference to FIGS. 5-7, the door-trim panel 24 has the vehicle-inboard face 32 and the recessed wall 34 recessed vehicle-outboard of the vehicle-inboard face 32 defining the map pocket 36. The vehicle-inboard face 32 is proud of the recessed wall 34 in a vehicle-inboard direction relative to the recessed wall 34. At least a portion of the vehicle-inboard face 32 and the recessed wall 34 may be unitary. In other words, the vehicle-inboard face 32 and the recessed wall 34 are of a single, uniform piece of material with no seams, joints, fasteners, or adhesives holding them together, i.e., formed together simultaneously as a single continuous unit, e.g., by molding. The map pocket 36 may be used, for example, to stow items including drinks, cellphones, refuse, etc. The map pocket 36 is adjacent the seat 12, as shown, for example, in FIGS. 1 and 8.

The door-trim panel 24 may include an inboard wall 72 connected to the vehicle-inboard face 32 and extending across the map pocket 36 vehicle-inboard from the recessed wall 34. The inboard wall 72 encloses a portion of the map pocket 36 for retention of materials stowed in the map pocket 36. The inboard wall 72 and the recessed wall 34 may be unitary. In other words, the inboard wall 72 and the recessed wall 34 are of a single, uniform piece of material with no seams, joints, fasteners, or adhesives holding them together, i.e., formed together simultaneously as a single continuous unit, e.g., by molding.

The polymeric block 38 is attached to and supported by the panel 28. As an example, the polymeric block 38 may be adhered to the panel 28 with an adhesive between the polymeric block 38 and the panel 28. As another example, the polymeric block 38 and the panel 28 may be unitary. In other words, the polymeric block 38 and the panel 28 are of a single, uniform piece of material with no seams, joints, fasteners, or adhesives holding them together, i.e., formed together simultaneously as a single continuous unit, e.g., by molding.

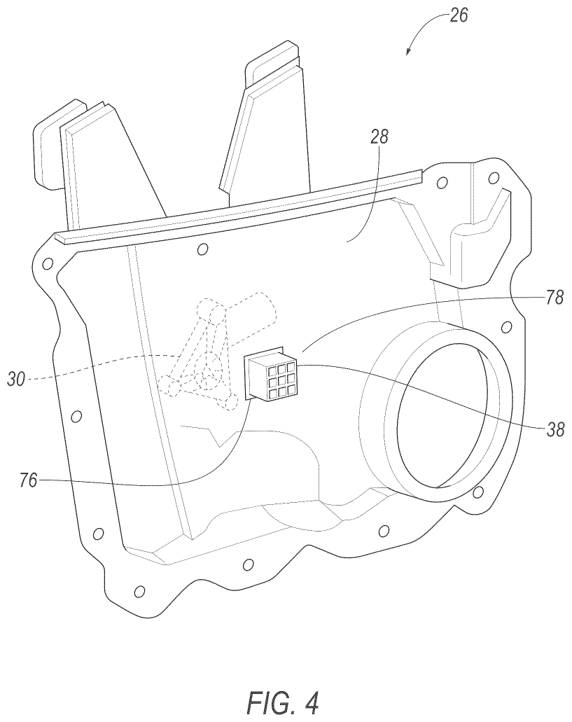

The polymeric block 38 is between the panel 28 and the door-trim panel 24. The polymeric block 38 extends from the panel 28 toward the door-trim panel 24. In the example shown in the Figures, e.g., FIGS. 5-7, the polymeric block 38 abuts the recessed wall 34 of the door-trim panel 24. The polymeric block 38 may be vehicle-forward of the window-regulator motor 30 and/or vertically aligned with the window-regulator motor 30, as shown in FIGS. 2-4.

The map pocket 36 is between the polymeric block 38 and the pelvic-seating area 18 when the door 20 is in the closed position, as shown in FIGS. 1 and 8. The alignment of the polymeric block 38 with the pelvic-seating area 18 reduces unoccupied cross-vehicle space between the exterior-door panel 22 and the pelvic-seating area 18. During certain impacts to the exterior-door panel 22 (e.g., due to certain vehicle impacts), vehicle-inboard deformation of the exterior-door panel 22 moves the polymeric block 38 into the map pocket 36 toward the pelvic-seating area 18, which deforms the recessed wall 34 toward the pelvic-seating area 18.

In some examples, the polymeric block 38 may include hollow cells 74 elongated cross-vehicle, as shown in FIGS. 2-4 and 8. In such examples, the cells 74 may have any suitable cross-sectional shape, e.g., square (as shown in the example in the Figures), honeycomb, round, etc.

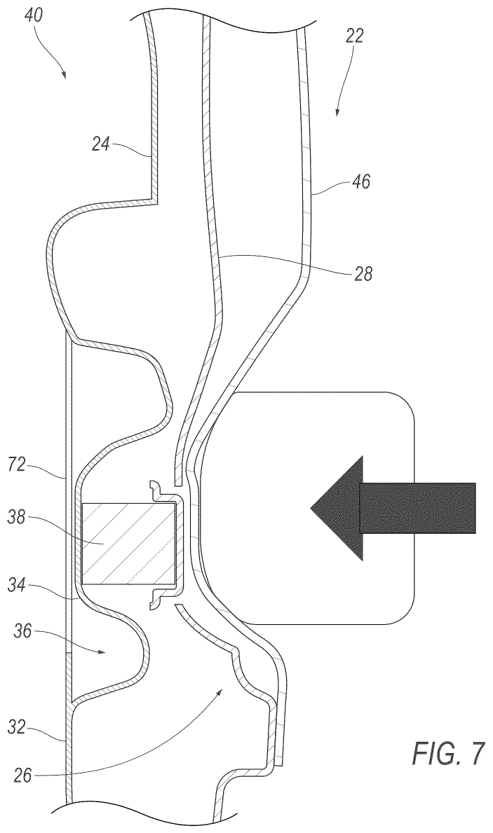

The panel 28 may include a weakened area 76 at the polymeric block 38. The weakened area 76 is designed to break from an adjacent area 78 of the panel 28 during certain vehicle impacts. The relative weakness of the weakened area 76 may be, for example, designed by decreased material thickness, geometry, etc. The weakened area 76 of the panel 28 is frangible relative to adjacent area 78 of the panel 28 that surrounds the weakened area 76. An example of breakage at the weakened area 76 is shown in FIG. 7.

The polymeric block 38 is formed of polymeric material. As an example, the polymeric block 38 may be plastic, e.g., polypropylene, acrylonitrile butadiene styrene (ABS), etc. As another example, the polymeric block 38 may be polyurethane, e.g., cellular polyurethane. The polymeric block 38 may be of the same type of material as the panel 28 or a different type of material than the panel 28. In examples in which the polymeric block 38 and the panel 28 are separately formed, the polymeric block 38 may be a different material type than the panel 28. In examples in which the polymeric block 38 and the panel 28 are unitary, the polymeric block 38 and the panel 28 may be of the same material type, e.g., molded from the same material.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A vehicle comprising:
a seat including a seat bottom and a seatback, the seat bottom defining a pelvic-seating area; and
a door adjacent to the seat and positioned vehicle-outboard of the seat, the door moveable between an open position and a closed position;
the door including an exterior-door panel and a door-trim panel supported by and fixed to the exterior-door panel vehicle-inboard of the exterior-door panel;
the door including a window-regulator assembly between the exterior-door panel and the door-trim panel;
the window-regulator assembly including a panel supported by and fixed to the exterior-door panel and a window-regulator motor supported by the panel of the window-regulator assembly;
the door-trim panel having a vehicle-inboard face and a recessed wall recessed vehicle-outboard of the vehicle-inboard face defining a map pocket, the map pocket being adjacent to the seat; and
the window-regulator assembly including a polymeric block attached to and supported by the panel, the map pocket being between the polymeric block and the pelvic-seating area when the door is in the closed position.

2. The vehicle as set forth in claim 1, wherein the door-trim panel includes a wall connected to the vehicle-inboard face and extending across the map pocket vehicle-inboard from the recessed wall.

3. The vehicle as set forth in claim 1, wherein the door includes a window track fixed relative to the panel of the window-regulator assembly and a window slidable along the window track, the window-regulator motor operatively coupled to the window to move the window along the window track.

4. The vehicle as set forth in claim 3, wherein the window-regulator assembly includes a regulator and a mechanism between the regulator and the window, the mechanism being designed to move the window relative to the window track.

5. The vehicle as set forth in claim 4, wherein the mechanism is between the exterior-door panel and the panel of the window-regulator assembly.

6. The vehicle as set forth in claim 3, wherein a portion of the window track extends between the exterior-door panel and the panel of the window-regulator assembly.

7. The vehicle as set forth in claim 3, wherein the panel of the window-regulator assembly provides a reaction surface for the window-regulator motor when the window-regulator motor moves the window relative to the window track.

8. The vehicle as set forth in claim 1, wherein the panel of the window-regulator assembly is fixed to the exterior-door panel with fasteners.

9. The vehicle as set forth in claim 1, wherein the polymeric block is adhered to the panel of the window-regulator assembly.

10. The vehicle as set forth in claim 1, wherein the panel includes a weakened area at the polymeric block, the weakened area designed to break from an adjacent area of the panel of the window-regulator assembly.

11. The vehicle as set forth in claim 1, wherein the polymeric block includes hollow cells elongated cross-vehicle.

12. The vehicle as set forth in claim 1, wherein the polymeric block abuts the recessed wall of the door-trim panel.

13. The vehicle as set forth in claim 1, wherein the polymeric block is vehicle-forward of the window-regulator motor.

14. The vehicle as set forth in claim 13, wherein the polymeric block is vertically aligned with the window-regulator motor.

15. The vehicle as set forth in claim 1, wherein the exterior-door panel includes a door inner panel and a door outer panel, the window-regulator assembly being fixed directly to the door inner panel.

16. The vehicle as set forth in claim 15, wherein the door-trim panel is fixed directly to the door inner panel.

17. The vehicle as set forth in claim 1, wherein the exterior-door panel is metal and the door-trim panel is polymeric.

18. The vehicle as set forth in claim 1, wherein the polymeric block is vehicle-forward of the window-regulator motor and vertically aligned with the window-regulator motor.

19. The vehicle as set forth in claim 1, wherein:
the polymeric block is adhered to the panel;
the panel includes a weakened area at the polymeric block, the weakened area being designed to break from an adjacent area of the panel; and
the polymeric block abuts the recessed wall of the door-trim panel.

20. The vehicle as set forth in claim 19, wherein the polymeric block is vehicle-forward of the window-regulator motor and vertically aligned with the window-regulator motor.
